(19) United States
(12) Patent Application Publication
(10) Pub. No.: US 2010/0320814 A1
(43) Pub. Date: Dec. 23, 2010

(54) SUPPORT AND HOLDING DEVICE FOR BICYCLE SADDLE

(76) Inventors: Rolf Singenberger, Echallens (CH); Ruedi Meiler, Schiers (CH); Reto Gasser, Baeriswil (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/746,255

(22) PCT Filed: Dec. 4, 2007
(86) PCT No.: PCT/EP2007/063304

§ 371 Date: Jun. 4, 2010

(51) Int. Cl. B62K 19/36

(52) U.S. Cl. 297/215.13

(57) ABSTRACT

With the present holding device for bicycle saddles with a seat tube (2) that can be inserted into a guide tube (1) of the frame of a bicycle, a saddle carrier (6) arranged at the upper end (2″) of the seat tube (2) as well as a clamping element (7) for fixing the position of the seat tube (2) in the guide tube (1), the clamping element (7) bears against the inner wall of the lower opening of the seat tube (2) at the lower end of the seat tube (2) in a longitudinally displaceable manner and is connected to a tension element (10). The tension element (10) is thereby arranged running in the interior of the seat tube (2) and is connected at its upper end to a holding element (20), wherein the holding element (20) is arranged in the seat tube (2) in a longitudinally displaceable manner with respect to the longitudinal axis (A) of the seat tube (2). The clamping element can thus be easily operated by displacing the holding element (20), which is arranged in the upper region (2″) of the seat tube (2), and a clamping effect between the seat tube (2) and the guide tube (1) from the inside can be achieved. No additional clamping means thus need to be arranged on the outside of the guide tube (1) as well as of the of the seat tube (2).

### RELATED APPLICATION

This is a U.S. national phase application under 35 U.S.C. §371 of International Application No. PCT/EP2007/063304 filed Dec. 4, 2007.

### TECHNICAL FIELD

The present invention relates to a holding device for a bicycle saddle with a seat tube that can be inserted into a guide arranged at the upper end of the seat tube as well as a clamping element for fixing the position of the seat tube in the guide tube.

### BACKGROUND AND SUMMARY

A holding device for a bicycle saddle, also referred to as a support device or seat post, is used for the attachment of the saddle to the frame of the bicycle. Depending on the type of bicycle, different seat posts are known with which the saddle is connected to the frame of the bicycle. Often the relative position of the saddle is thereby embodied to be adjustable with respect to the frame. The saddle can thus be individually adjusted taking into account the body measurements of the respective cyclist with respect to his position and distance respectively from the pedal axis and from the handlebars.

In a simplest embodiment, the saddle is attached to the head of a rod that can be fixed in the frame of the bicycle in a longitudinally displaceable manner. The distance of the saddle from the pedal axis can thus be individually adjusted according to the length of the user's legs in order to render possible an optimal sequence of motions for pedaling. The fixing of the rod is thereby carried out, for example, by clamping the rod arranged in the frame in a displaceable manner by means of a clamping device to be actuated by means of a screw. In a typical embodiment, the frame is embodied as a tube to accommodate the rod, in the opening of which tube the saddle rod is inserted, wherein the opening region of the frame can be compressed by means of a band in order to clamp and thus to fix the saddle rod in the desired position. However, this construction requires a frame of a clampable material, at least in the region of the transition to the rod.

In order to increase the seat comfort, as a rule the tilt angle of the saddle can also be adjusted with respect to the saddle rod. The saddle is thereby connected to the saddle rod, for example, via a bolt provided with a thread in a rotatable or pivotable manner.

As a rule, these known solutions have an individual, separate attachment device and locking device respectively for each adjustment and positioning option, which attachment device and locking device in each case has to be operated separately.

Since the rod thus must transmit great forces during operation from the saddle into the frame as well as accommodate the attachment elements and adjustment elements, very high demands are to be made on the strength of the rod. These can be met by a corresponding of material selection, which, however, also often results in high weights of these rods.

The object of the present invention was now to propose a support for bicycle saddles which with the lowest possible weight permits a simple adjustability as well as a reliable attachment of the bicycle saddle.

This object is attained according to the invention by the holding device for bicycle saddle as referred to above, wherein the clamping element bears against an inner wall of a lower opening of the seat tube at a lower end of the seat tube in a longitudinally displaceable manner and is connected to a tension element, wherein the tension element is arranged running in the interior of the seat tube and is connected at an upper end of the tension element to a holding element, wherein the holding element is arranged in the seat tube in a longitudinally displaceable manner with respect to a longitudinal axis of the seat tube. Further embodiments of the invention are defined hereinafter.

With the holding device for bicycle saddles with a seat tube that can be inserted into a guide tube of the frame of a bicycle, a saddle carrier arranged at the upper end of the seat tube as well as a clamping element for fixing the position of the seat tube in the guide tube, according to the invention the clamping element bears against the inner wall of the lower opening of the seat tube at the lower end of the seat tube in a longitudinally displaceable manner and is connected to a tension element. The tension element is thereby arranged running in the interior of the seat tube and is connected at its upper end to a holding element, wherein the holding element is arranged in the seat tube in a longitudinally displaceable manner with respect to the longitudinal axis of the seat tube. The clamping element can thus be operated easily by displacing the holding element, which is arranged in the upper region of the seat tube, and a clamping effect can be achieved between the seat tube and the guide tube from the inside. Thus no additional clamping means need to be arranged on the outside of the guide tube or of the seat tube. Thus, for example, the guide tube can be embodied as a simple tube with a simple end and opening respectively, which is an advantage for the production of the frame.

For example, the head of the clamping element, at least in the region of the bearing against the inner wall of the seat tube, has a conical outer surface with respect to the longitudinal axis of the seat tube. Due to the conicity of the outer surface of the clamping element, the seat tube is expanded outwards at its opening of the lower end during the displacement of the clamping element, and thus for its part causes a pressing effect on the inner wall of the guide tube, with which the seat tube is fixed in the respective position relative to the guide tube.

For this purpose, the seat tube is embodied at this point, for example, to be radially partially elastic or in this region has a slot at the side, which slot permits an expansion or reduction of the outer diameter of the seat tube.

The clamping effect is thereby advantageously achieved only via the press fit between the outer wall of the seat tube and the inner wall of the guide tube without further locking means or devices having to be used, which either engage in the guide tube and/or the seat tube or have to be connected thereto in a positive or non-positive manner.

For example, the head of the clamping element has a cover surface running at angle to the longitudinal axis of the seat tube. Thus a circumferential line of the edge of the clamping element enlarged compared to the sectional area running at right angles to the longitudinal axis is achieved and thus also a correspondingly enlarged pressure area or pressure edge towards the seat tube. A comparable or larger clamping force of the clamping element and of the seat tube respectively with respect to the guide tube is thus already achieved with a smaller tensile force on the clamping element. For example, the clamping element is composed of metal and is preferably structured in one piece. The clamping element can be produced, for example, from a light alloy, which makes it possible to apply and transfer high forces into the clamping element with the lowest weight.

For example, the seat tube has a drop-shaped cross section that extends at least from the lower opening of the seat tube over most of the length of the seat tube. Because the fixing of the seat tube is realized via a press fit between the inner surface of the guide tube and the outer surface of the seat tube, advantageously virtually any cross-sectional shape can be selected. It has been shown that a drop shape is advantageous not least for aerodynamic reasons, wherein, for example, the bulge is embodied in the front in the direction of travel of the frame and the tip is embodied at the rear in the direction of travel of the frame.

For example, the seat tube at its upper end has an essentially closed head region, preferably a head region having essentially a flat bearing surface. The closed design on the one hand prevents dirt and moisture from being able to penetrate into the interior of the seat tube. Furthermore, the saddle carrier can thus be connected in a stable manner to the head of the seat tube.

With a flat bearing surface, a particularly good power transfer can take place from the saddle carrier into the seat tube, and different types of saddle carriers can be used universally.

For example, at least two openings for the accommodation and through guidance of attachment means for the saddle carrier are embodied in the head region of the seat tube, which openings are accessible from the outside from the lower side and are continuous to the bearing surface. For example, respectively one opening on the front and one opening on the back of the seat tube are thereby arranged to accommodate attachment screws as attachment means.

For example, the seat tube is composed of plastic, preferably of fiber-reinforced plastic, preferably of carbon fiber-reinforced plastic. The use of the clamping element permits the use of plastic, in particular of fiber-reinforced plastic as a material for the seat tube, since no special force transfer elements have to be embodied for the clamping connection to the guide tube. The seat tube can thus be realized to be particularly light with a high strength.

For example, the holding element has a pin, the ends of which are arranged eccentrically in round adjusting disks, which are hinge-mounted in bushings that are arranged in the wall of the seat tube so as to be accessible from outside. Thus on the one hand the displacement of the holding element and the tension element respectively can be carried out simply by a rotary motion, and on the other hand the respective position has a stable location, i.e., it is virtually impossible for it to shift by itself Advantageously, a precise and stable locking effect can thus be achieved. The rotary motion permits the use of simple tools for loosening and tightening the connection.

Furthermore, the actuator can thus be easily integrated into the shape of the seat tube, without interfering elements projecting from the outer surface of the seat tube. This has aerodynamic advantages and reduces the risk of injury due to projecting parts.

For example, the adjusting disks and/or the bushings have stop means for limiting the angle of rotation of the adjusting disk supported in the respective bushing. A clearly defined position of the tension element for the clamping position as well as for the released position of the clamping element is thus realized. For example, this reliably prevents too great a force from being applied for the clamping position, which could damage the seat tube and/or the guide tube, such as can be the case with known solutions, for example, with screw clamps.

For example, the tension element has a tie rod, which opens at both of its ends into connecting elements, wherein the tie rod is preferably composed of a fiber material or a fiber composite material and the connecting elements are composed of metal. A very light construction is thus provided, which at the same time can transfer very high forces. The force diversion from the tie rod is released reliably and in a stable manner by the connecting elements. It is therefore also possible to provide there, for example, adjusting means in order to precisely adjust the length of the tension element, for example, in the form of screw elements. Thus, for example, the specialist in the assembly of the bicycle and of the seat tube respectively can precisely adjust the length of the tension element so that an optimum clamping effect can be achieved without damage to the seat tube.

For example, the saddle carrier is embodied in two parts with a saddle clamp and a hold-down device, wherein the hold-down device is preferably connected to the seat tube by means of two attachment means. Different saddle models can thus be connected universally and easily to the seat tube. If the clamping effect of the saddle carrier is realized via the attachment means, an optimal force transfer into the seat tube can be realized thereby.

### BRIEF DESCRIPTION OF DRAWINGS

An exemplary embodiment of the present invention is explained in more detail below based on figures. They show:

FIG. 1 Diagrammatically the representation of a conventional bicycle frame with inserted seat tube;

FIG. 2 The view of an embodiment of a seat tube according to the invention in a partial longitudinal section, without a saddle;

FIG. 3 The perspective representation of the elements of the holding element of the seat tube according to FIG. 2;

FIG. 4 In more detail the view of the head region of the seat tube according to FIG. 2 with fitted saddle holder;

FIG. 5 The perspective representation of a fully equipped seat tube according to the invention according to the embodiment according to FIG. 2.

### DETAILED DESCRIPTION

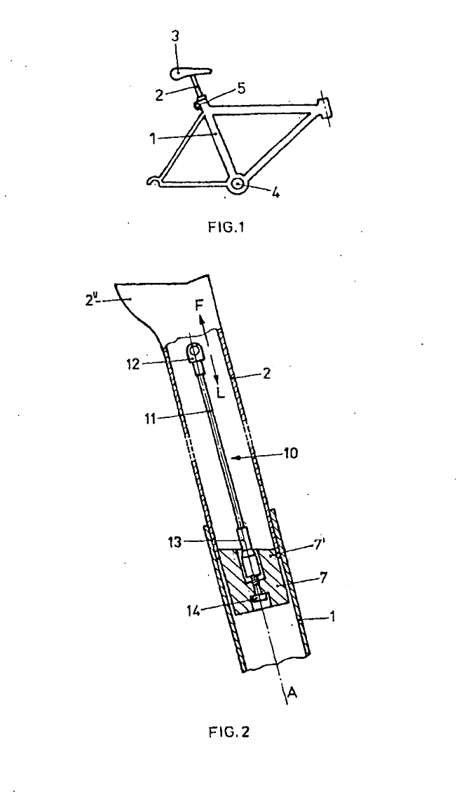

FIG. 1 shows purely by way of example the view of a conventional bicycle frame, in the central frame tube 1 of which a seat tube 2 is guided in a displaceable manner in the axial direction. A saddle 3 is arranged in a conventional manner, for example adjustable in terms of tilt, on the upper head end of the seat tube 2. The adjustment of the distance of the saddle 3 from the hub 4 of the drive axis of the frame is carried out, as mentioned, by the axial displacement of the seat tube 2 inside the frame tube 1 of the frame. The fixing of the seat tube 2 in the desired position is carried out conventionally, for example, by means of a clamp 5, which acts on the frame tube 1 in the region of its opening for the seat tube 2 and thus reduces the opening cross section and exerts a clamping effect on the seat tube 2.

FIG. 2 shows diagrammatically the partial longitudinal cross section through a seat tube 2 according to the invention. The lower part of the seat tube 2 is inserted into the opening of the frame tube 1 and can be displaced along the longitudinal axis A of the frame tube 1. The height of the saddle (not shown), which is connected to the head 2″ of the seat tube 2, can thus be individually adjusted with respect to the frame according to the size and the needs respectively of the rider of the bicycle. In order to fix the adjusted position, a clamping element 7 is inserted into the lower opening of the seat tube 2 and displaced upwards in the direction of the arrow F by means of the tension element 10.

Because the clamping element 7 has a slight conicity in the head region 7′, during the insertion movement the cross section of the lower opening of the seat tube 2 is expanded, whereby a clamping fit is achieved between the outer surface of the seat tube 2 and the inner surface of the frame tube 1, and the seat tube 2 is thus fixed with respect to the frame tube 1.

Through the movement of the tension element 10 downwards in the direction of the arrow L, the clamping fit is released again, in that the clamping element 7 is thereby displaced downwards with respect to the seat tube 2. The seat tube 2 can thus be displaced again with respect to the frame tube 1 and brought into a different position. The clamping element 7 is thereby displaced independently downwards with tensile action from outside on the seat tube 2 so that the tension element 10 remains unloaded.

For example, the head region 7′ of the clamping element 7 is embodied at an angle with respect to the longitudinal axis A of the frame tube 1, whereby the edge of the head region 7′ or the circumferential line thereof or circumferential surface thereof is enlarged, which leads to a larger force transmission surface or clamping surface. A clamping force sufficient for fixing the seat tube 2 can thus already be achieved with a slight tensile force in the direction of the arrow F. The large clamping surface further prevents an only limited force application point, such as, for example, a thin ring, from being formed, which leads to high pressure loads on the material and, for example, with the use of carbon fibers for the frame tube, it can break at such points.

It is clear to one skilled in the art that the clamping element 7 can also be embodied in a different form as a wedge and advantageously can be simply adjusted to the cross section of the seat tube 2. In addition to round cross sections, other cross-sectional shapes can thus also be easily realized. It has been shown that, for example, a drop-shaped cross section has aerodynamic advantages with the same or better strength. A cross-sectional shape of this type can easily be realized with a clamping element 7 and a seat tube 2. Furthermore, the alignment of the saddle clamp 6 and thus of the saddle is thereby also defined and positioned, as a rule precisely in the longitudinal axis of the bicycle, which permits a clamping with lower clamping forces than with conventional circular cross-sectional shapes, with which the twisting of the saddle clamp 6 also has to be prevented.

A great advantage of this clamping construction is to be seen in that no damage or contacts take place on the surface of the frame tube 1, as is the case with conventional attachment devices, for example, with clamping U-bolts. Furthermore, materials can thus also be used which can be loaded under compression which, however, permit spanning force connections only with complex constructions, such as, for example, plastics or in particular carbon fiber materials.

Of course, this type of clamping is also suitable for metals, in particular for metals sensitive to notch effect, such as high-strength light metals.

Through the clamping force acting along the entire circumference of the lower opening of the seat tube 2, an optimum force application and force transmission without punctiform peaks is achieved, whereby no undesirable punctiform deformations can occur.

The tension element 10, as already mentioned at the outset, is subjected virtually only to tensile stress, so that it can be specifically designed for this load. For example, it is composed of a tie rod or tension string 11, which respectively opens into connecting elements 12 and 13 respectively. The tie rod 11 is composed, for example, of light carbon, while the two connecting elements 12 and 13 respectively are embodied as metal fittings. The lower connecting elements 13 is embodied, for example, as a screw element, so that the length between the clamping element 7 and the upper connecting element 12 can be precisely adjusted. In the example shown this is realized by a screwed socket in the connection element 13, into which a screw 14 inserted from below into the clamping element 7 is screwed. Under tensile stress a precisely adjustable distance between the clamping element 7 and the upper connecting element 12 is thus realized, while with unloading of the tie rod 11 the lower clamping element 13 can move downwards, so that no pressure load can be transferred to the tie rod 11, even if the clamping element 7 remains temporarily in its upper clamping position. With tensile action from outside on the seat tube 2, the clamping element 7 moves independently downwards out of the clamping position and release the seat tube 2 with respect to the guide tube 1.

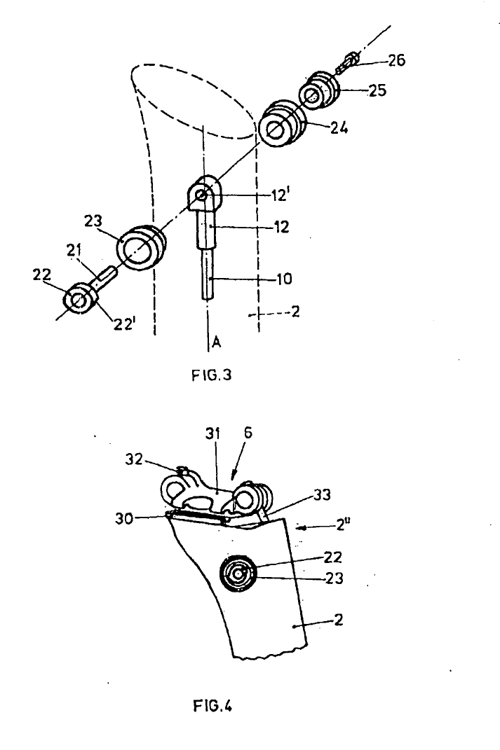

The upper connecting element 12 has an eye 12′ into which the journal 21 of a holding element 20 engages, as is shown diagrammatically in FIG. 3.

The journal 21 has on its one end a disk-like head 22, which is inserted from outside into a bushing 23 and is hinge-mounted there. The bushing 23 is inserted on one side in the wall of the seat tube 2 (contour shown by a dashed line). On the opposite wall of the seat tube 2 a further bushing 24 is sunk, which accommodates a further disk 24 in a rotatable manner. The other end of the journal 2 is connected to this disk 25, for example, by means of a screw 26. The journal 21 is arranged eccentrically according to the invention with respect to the axis of rotation of the head 22 and of the disk 25 respectively in the respective bushings 23 and 24 respectively. Thus with a rotation of the head 22, the journal 21 is displaced relative to the axis A of the seat tube 2, i.e., upwards or downwards, which results in the fixing or releasing of the clamping element 7 in the seat tube 2 or guide tube.

For a simple rotation of the head 22, this has on its outside, for example, a simple slot or an edge slot for the insertion of a corresponding tool, such as, for example, a screwdriver.

For example, radial stop edges 22′ can be formed on the circumference of the head 22, which reach a stop at corresponding stops on the inside of the bushing 23 and thus limit the twist angle of the head 22 in the bushing 23. Two defined end positions of the head 22 can thus be provided, which, for example, establish the uppermost and the lowest position of the journal 21 with respect to the longitudinal axis A of the seat tube 2. A complete opening and closing respectively of the clamping element 7 is thus possible without there being a risk of an overloading of the tension element 10 or the fit of the clamping element 7 is adjusted to be too weak due to a tensile force that is too weak and the height of the saddle carrier 6 could thus shift accidentally and independently.

The limit elements can of course also be arranged on the disk 25, either alone or in addition to the limit elements of the head 22.

The tensile force of the tension element 10 is optimally transmitted into the wall of the seat tube 2 via the head 22 and the disk 26 respectively and the bushings 23 and 24 respectively. Because the bushings 23 and 24 respectively, for example, are sunk virtually completely into the wall of the seat tube 2, virtually no part protrudes from the holding element 20 to the outside. On the one hand this is advantageous aerodynamically and also reduces the risk of injury to the rider of the bicycle.

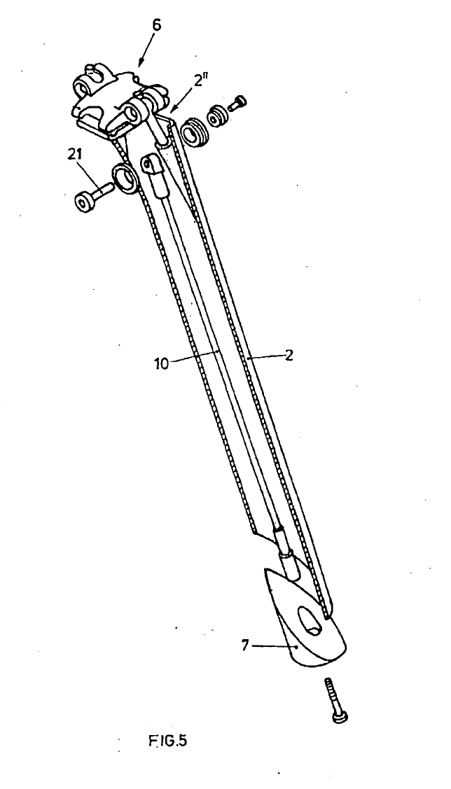

FIG. 4 shows the side view of the head region of the seat tube according to FIG. 2 with fitted saddle carrier 6. Here initially the head 22 of the holding element 20 inserted into the bushing 23 can be seen well, which is let into the wall of the seat tube virtually completely recessed.

The seat clamp 6 is arranged at the upper end 2″ of the seat tube 2, wherein, for example, the saddle clamp 30 bears against a flat head surface of the seat tube 2 and the hold-down device 31 arranged above it is connected to the head of the seat tube 2 by means of two screws 32 and 33 respectively.

The saddle clamp 30 is thereby embodied as an essentially rectangular disk with two half slots 30′ arranged in parallel and open to above, in which, for example, the attachment tubes of the saddle (not shown) can be inserted in a longitudinally displaceable manner. These attachment tubes are pressed through the noses if the hold-down device 31 against the saddle clamp 30 and fixed there thereby.

The screws 32 and 33 are guided from below through corresponding channels or openings in the outside of the seat tube 2 and thus conduct the saddle forces into the seat tube 2 in an optimal manner This arrangement of the connecting elements is also aerodynamically advantageous that there are no parts projecting to the outside and a possible risk of injury on sharp edged connecting elements is also reliably prevented thereby.

FIG. 5 shows diagrammatically again for a better overview a complete seat tube 2 according to the invention in partial section. Here the beveled head region 7′ of the clamping element 4 can be seen particularly well, as well as the guide of the connecting screws of the saddle carrier 6.

These can be embodied, for example, as sleeves with an internal thread, which are connected in a hinged manner to the hold-down device 31, and into which screws inserted from the underside of the head region of the seat tube engage. Through the clamping connecting, the position of the saddle relative to the saddle holder and to the head region of the seat tube 2 can thus be easily individually adjusted.

The seat tube 2 can thus be embodied, for example, as an extremely light carbon fiber constriction without there being any danger of damage to the sensitive surface of the seat tube 2 by improper operation of the height adjustment of the seat tube.

Of course, the device according to the invention can also be inserted into frame tubes of metal. Likewise, the device according to the invention is also suitable for retrofitting existing bicycles.

1. A holding device for bicycle saddle (3), the holding device comprising:
a seat tube (2) that can be inserted into a guide tube (1) of a frame of a bicycle,
a saddle carrier (6) arranged at an upper end of the seat tube (2),
a clamping element (7) for fixing the position of the seat tube (2) in the guide tube (1),
wherein the clamping element (7) bears against an inner wall of a lower opening of the seat tube (2) at a lower end of the seat tube (2) in a longitudinally displaceable manner and is connected to a tension element (10),
wherein the tension element (10) is arranged running in the interior of the seat tube (2) and is connected at an upper end of the tension element to a holding element (20),
wherein the holding element (20) is arranged in the seat tube (2) in a longitudinally displaceable manner with respect to a longitudinal axis of the seat tube (2).

2. Holding device according to claim 1, wherein a head of the clamping element (7), at least in the region of the bearing against the inner wall of the seat tube (2), has a conical outer surface with respect to the longitudinal axis of the seat tube (2).

3. Holding device according to claim 2, wherein the head of the clamping element (7) has a cover surface running at angle to the longitudinal axis of the seat tube (2).

4. Holding device according to claim 1, wherein the clamping element (7) is composed of metal and is structured in one piece.

5. Holding device according to claim 1, wherein the seat tube (2) has a drop-shaped cross section that extends at least from the lower opening of the seat tube (2) over most of the length of the seat tube (2).

6. Holding device according to claim 1, wherein the seat tube (2) at its upper end has an essentially closed head region having essentially a flat bearing surface.

7. Holding device according to claim 1, further comprising at least two openings for the accommodation and through guidance of attachment means for the saddle carrier, the at least two opening being embodied in the head region of the seat tube (2), accessible from the outside from the lower side and continuous to the bearing surface, respectively one opening on the front and one opening on the back of the seat tube to accommodate attachment screws as attachment means.

8. Holding device according to claim 1, wherein the seat tube (2) is composed of carbon fiber-reinforced plastic.

9. Holding device according to claim 1, wherein the holding element (20) has a pin (21), the ends of the pin being arranged eccentrically in round adjusting disks (22) hinge-mounted in bushings (23) arranged in the wall of the seat tube (2) so as to be accessible from outside.

10. Holding device according to claim 9, wherein at least one of the adjusting disks (22) and the bushings (23) have stop means for limiting the angle of rotation of the adjusting disk (22) supported in the respective bushing (23).

11. Holding device according to claim 1, wherein the tension element (10) has a tie rod (11), which opens at both of its ends into connecting elements (12; 13), wherein the tie rod (11) is composed of a fiber material or a fiber composite material and the connecting elements (12; 13) are composed of metal.

12. Holding device according to claim 1, wherein the saddle carrier (6) is embodied in two parts with a saddle clamp and a hold-down device, wherein the hold-down device is connected to the seat tube (2) by means of two attachment means.
